(19) United States
(12) Patent Application Publication
(10) Pub. No.: US 2010/0170145 A1
(43) Pub. Date: Jul. 8, 2010

(54) Catalyst for production of biodiesel and its production method, and method for producing biodiesel

(76) Inventors: Yuji Ueki, Gunma (JP); Masao Tamada, Gunma (JP)

Correspondence Address: WENDEROTH, LIND & PONACK, L.L.P., 1030 15th Street, N.W.,, Suite 400 East, Washington, DC, 20005-1503, US

(21) Appl. No.: 12/654,560

(22) Filed: Dec. 23, 2009

(30) Foreign Application Priority Data
Dec. 26, 2008 (JP) 2008-334433

(51) Int. Cl. C10L 1/19; B01J 31/06

(52) U.S. Cl. 44/388; 502/159

(57) ABSTRACT

A fibrous catalyst for production of biodiesel by transesterification of oil/fat and alcohol, in which a graft chain is introduced into a polymer fiber substrate through graft polymerization, and the graft chain has one or more functional groups selected from amino groups and quaternary ammonium groups, and a hydroxide ion. The catalyst for biodiesel production can produce a large quantity of biodiesel efficiently in a short period of time

### TECHNICAL FIELD

The present invention relates to a catalyst for production of biodiesel and its production method, and to a method for production of biodiesel.

### BACKGROUND ART

Oils/fats have a higher heating value as compared with other biomass resources, and many of them are liquid at ordinary temperatures. These characteristics are hopeful as automobile fuel; as they are, however, they have a high kinematic viscosity (>30 mm²/s (40° C.)) and a high ignition point (>300° C.), and have a low cetane number of around 40, and therefore, they could not be utilized. On the other hand, fatty acid esters to be produced through transesterification of oil/fat and alcohol have a low kinematic viscosity (3 to 5 mm²/s (40° C.)) and a low ignition point (around 160° C.), and have a cetane number of from 50 to 60 or so, and their properties are relatively near to those of light gas oil, and they are specifically noted as fuel substitutive for light gas oil. The fatty acid ester is referred to as biodiesel fuel (hereinafter this may be simply referred to as biodiesel), and as compared with conventional petroleum diesel fuel (light gas oil), this has the following characteristics.

1) As derived from biomass resources, carbon dioxide to be generated by the use of biodiesel fuel does not have any influence on the increase/decrease in the amount of carbon dioxide in the global environment (carbon-neutral).

2) The plant to be the starting material can be produced in user countries, and the dependency on petroleum resources can be reduced.

3) As compared with those from light as oil, noncombustible hydrocarbon in the exhaust gas ingredients can be reduced by 93%, carbon monoxide by 50% and suspended particulate matter by 30%.

4) Not containing a sulfur ingredient, the sulfur oxide (SOx) in the exhaust gas is nearly zero.

5) As compared with light gas oil, biodiesel fuel has a high ignition point, and during combustion, it contains oxygen and promotes complete combustion, and therefore the emission of dark smoke from biodiesel fuel can be reduced to from ⅓ to 1/10 that from light gas oil.

6) Since biodiesel fuel can be used in any and every diesel engine with no modification directly as it is, and its fuel cost is equivalent to that of light gas oil.

7) As well biodegradable, biodiesel fuel can be handled with safety.

As described in the above, the approach to positively utilizing biodiesel fuel having a lot of more excellent characteristics than those of petroleum diesel fuel is being gradually activated in recent years. Especially in Europe and the United States, use of biodiesel fuel is being popularized, and mixed fuel thereof with light gas oil has become widely used.

Some methods of industrial production of biodiesel from oil/fat have been developed; and at present, an alkali catalyst method of using a homogeneous catalyst of sodium hydroxide, potassium hydroxide or the like is the mainstream. According to the alkali catalyst method, the reaction may be carried out under a relatively mild temperature/pressure condition; however, the method has some problems in that it requires a step of separating and removing the alkali catalyst dissolved in biodiesel in the stage of purification, that the free fatty acid in the starting oil/fat reacts with the alkali catalyst to produce soap, that the catalyst is difficult to recycle, and that water in the starting oil/fat lowers the catalyst function; and in addition, the method involves a number of risk factors of production cost increase and environmental load increase. Recently, as a biodiesel production method not requiring a complicated catalyst separating step and not producing side products, new methods are being studied, such as an acid catalyst method, a lipase enzyme method, a supercritical methanol method, a metal oxide method, a solid catalyst method and the like (Non-Patent Reference 1). However, these methods still have some problems in that high temperature/high pressure is needed, the catalyst regeneration is difficult, the catalyst is expensive, the catalyst activity is low, the reaction speed is slow, and the alcohol addition amount control is, indispensable; and therefore, it is said that these methods are unfavorable for industrial use.

As a biodiesel production method, use of a solid basic catalyst is also tried, and as such a solid basic catalyst, an amino group—having anion exchange resin is proposed (Patent Reference 1). According to the method of using such an anion exchange resin, the catalyst does not dissolve in the reaction system, and therefore a step of separating the catalyst may be omitted; however, in the method, the transesterification is carried out in the presence of a large excessive amount of alcohol to such a degree that the triglyceride concentration in the reaction system is from 0.1 to 3% by weight or so, and therefore the method has some problems in that the catalyst activity is extremely low and the biodiesel producibility is low, and the method is not practicable. Yonemoto et al. have proposed, as a modification technique over Patent Reference 1, a biodiesel production method using a porous anion exchange resin as a catalyst (Patent Reference 2, Non-Patent Reference 2). According to the method of using a porous anion exchange resin, they say that the triglyceride concentration is desirably from 38.9 to 95.0% by weight (molar ratio of oil/fat to alcohol=1/30 to 1/1) to be high-concentration solution, contrary to the desirable fact that the triglyceride concentration in the reaction system is from 0.1 to 3% by weight to be a dilute solution, as so explicitly mentioned in Patent Reference 1; and in addition, since a hydroxyl group is not free in the reaction solution therefore not causing saponification, and accordingly, production of side products and catalyst activity reduction with it can be prevented. However, in case where a porous anion exchange resin is used as a catalyst, sample diffusion into the pores of the catalyst is rate-limiting since the catalyst has a reaction site inside the pores thereof owing to the structure of the catalyst. Accordingly, the reaction speed is slow; and even in the method proposed by Yonemoto et al., the transesterification takes 3 hours or more, and therefore, for industrialization of biodiesel production and for large-scale mass-production of biodiesel, further catalyst improvement is an urgent need.

On the other hand, the present inventors have reported a graft polymer as an ion exchanger that secures high reaction speed and enables high-speed processing with it (Patent Reference 3). The graft polymer may be produced through direct introduction of a polymer chain (graft chain) into the surface of a polymer substrate according to a radiation-grafting polymerization method of a radiation-assisted polymer processing technique. In the radiation-grafting polymerization method, radiation-derived high energy is used; and therefore the method has few limitations on the aspect of polymer production, and graft polymers of various forms such as fibers, woven fabrics, nonwoven fabrics, flat membranes, films and the like can be produced with ease. In particular, a graft polymer with a substrate of a fibrous polymer having a large specific surface area and having a high-level contact efficiency may have a metal adsorption speed higher by from 10 to 100 times or so than that of conventional granular resins, and can be handled in a simplified manner (Non-Patent Reference 3). The graft polymer having such excellent characteristics is used for collection and removal of minor metal elements existing in environmental water such as river water, seawater, etc.

The present inventors have further developed the technique and have found that a polymer produced by introducing an amino group and a quaternary ammonium group into the graft chain of the above-mentioned graft polymer exhibits an extremely excellent catalytic capability in production of biodiesel through transesterification of oil/fat and alcohol. Heretofore, an ordinary catalyst for use in production of biodiesel generally comprises a granular resin as a carrier with an amino group and a quaternary ammonium group introduced thereinto; however, the present inventors have assiduously studied the above-mentioned graft polymer and, as a result, have found that, when the graft polymer is used as a catalyst, then the reaction rate of transesterification of oil/fat and alcohol is enhanced, and have reached the present invention. The graft polymer technology which the present inventors have previously reported is a technique relating to a metal adsorbent, and its technical field quite differs from the technical field of biodiesel production; and therefore, anyone skilled in the art could not hit on the present invention based on the above-mentioned graft polymer technology.

Biodiesel is produced through transesterification of a non-polar liquid, oil/fat and a polar liquid, alcohol; and the two reactants are, in general, not mixed in the reaction system but are separated in two phases. Accordingly, the transesterification goes on only in the liquid/liquid contact interface, and as a result, the reaction speed is low and the reaction is unsuitable to efficient production of biodiesel. To solve the problem about the reaction speed in biodiesel production, an efficient stirring method and stirring chamber for producing fine liquid droplets are developed and other novel techniques of transesterification in a homogeneous phase using an auxiliary solvent and the formed biodiesel (Patent References 4 to 6) are studied and developed as a method of enlarging the contact interface between oil/fat and alcohol to thereby enhance the reaction efficiency, apart from the development and utilization of novel ion exchangers. However, in the development of a novel stirring system and stirring chamber requires, the formation of fine liquid droplets requires a high-level technique and conventional devices could not be used, and therefore this is problematic in point of the technical aspect and the cost aspect. On the other hand, the transesterification in a homogeneous phase using an auxiliary solvent does not require any sophisticated stirring operation since the reaction system could be in a homogeneous phase, and a sufficiently high reaction speed could be attained even at a slow stirring speed; however, after the reaction, the auxiliary solvent must be separated and removed from the product, and an additional apparatus for auxiliary solvent removal is needed, therefore resulting in cost increase.

[Patent Reference 1] JP-B 6-006718.

[Patent Reference 2] JP-A 2006-104316.

[Patent Reference 3] JP-A 2005-344047.

[Patent Reference 4] Canadian Patent 2,131,654.

[Patent Reference 5] JP-T 2003-507495.

[Patent Reference 6] JP-T 2006-524267.

[Non-Patent Reference 1] Shiro Saka, Eiji Minami, Hideki Fukuda; A to Z of Biodiesel, IPC, 82-134, 2006.

[Non-Patent Reference 2] N. Shibasaki-Kitakawa, H. Honda, H. Kuribayashi, T. Toda, T. Fukumura, T. Yonemoto, Biodiesel production using anionic ion-exchange resin as heterogeneous catalyst, Bioresour. Technol., 98; 416-421, 2007.

[Non-Patent Reference 3] S. Aoki, K. Saito, A. Jyo, A. Katakai, T. Sugo, Phosphoric Acid Fiber for Extremely Rapid Elimination of Heavy Metal Ions from Water, Anal. Sci., 17 Suppl., i205-208, 2001.

### DISCLOSURE OF THE INVENTION

### Problems that the Invention is to Solve

The present invention has been made in consideration of the above-mentioned situation, and its object is to provide a catalyst for biodiesel production with which a large quantity of biodiesel can be produced efficiently at a low cost within a short period of time, and its production method and a method for producing a biodiesel.

### Means for Solving the Problems

The present invention is characterized by the following, for solving the above-mentioned problems.

First, there is provided a fibrous catalyst for production of biodiesel by transesterification of oil/fat and alcohol, wherein a graft chain is introduced into a polymer fiber substrate through graft polymerization, and the graft chain has one or more functional groups selected from amino groups and quaternary ammonium groups, and a hydroxide ion.

Secondly, in the above-mentioned first invention, the polymer fiber substrate is a thread-like one or a fiber aggregate of a woven fabric, a nonwoven fabric or a hollow yarn membrane.

Thirdly, in the above-mentioned first or second invention, the mean fiber diameter of the polymer fiber substrate is from 1 μm to 50 μm.

Fourthly, there is provided a method for producing the catalyst for biodiesel production of any of the above first to the third, which comprises a step of activating a polymer fiber substrate, a step of contacting the activated polymer fiber substrate with a solution containing an active monomer to thereby graft-polymerize the polymer fiber substrate with the reactive monomer, a step of introducing one or more functional groups selected from amino groups and quaternary ammonium groups into the graft chain of the graft-polymerized polymer fiber substrate, and a step of alkali-processing the graft-polymerized polymer fiber substrate.

Fifthly, there is provided a method for producing the catalyst for biodiesel production of any of the above first to the third, which comprises a step of activating a polymer fiber substrate, a step of contacting the activated polymer fiber substrate with a solution that contains an active monomer having one or more functional groups selected from amino groups and quaternary ammonium groups to thereby graft-polymerize the polymer fiber substrate with the reactive monomer, and a step of alkali-processing the graft-polymerized polymer fiber substrate.

Sixthly, there is provided a method for producing a biodiesel, which comprises contacting oil/fat and alcohol with the biodiesel production catalyst the above-mentioned first or second invention to thereby produce a biodiesel through transesterification of oil/fat and alcohol.

Seventhly, in the above-mentioned sixth invention, the oil/fat is any of natural oil/fat, synthetic oil/fat, monoglyceride, diglyceride, synthetic triglyceride, their modificates, or waste oil/fat containing any of them.

Eighthly, in the above-mentioned sixth or seventh invention, the alcohol includes one or more mixed alcohol selected from linear or branched alcohols having from 1 to 18 carbon atoms.

Ninthly, in any of the above-mentioned sixth to eighth inventions, the reaction temperature falls within a range of from 10° C. to 100° C.

### BRIEF DESCRIPTION OF THE DRAWINGS

FIG. 1 This shows alkali processing of graft polymers with an amino group or a quaternary ammonium group introduced thereinto.

FIG. 2 This shows a degree of grafting relative to the irradiation dose as a result of the verification experiment in Example 1.

FIG. 3 This is a chromatogram after transesterification in different reaction times as a result of the verification experiment in Example 2.

FIG. 4 This shows a reaction rate of triglyceride relative to the type of the catalyst as a result of the verification experiment in Example 2.

FIG. 5 This shows a reaction rate of triglyceride relative to the transesterification temperature as a result of the verification experiment in Example 3.

FIG. 6 This is a chromatogram after transesterification in different cases of using different alcohols as a result of the verification experiment in Example 4.

FIG. 7 This is a chromatogram after transesterification in a case of using rapeseed oil as a result of the verification experiment in Example 5.

FIG. 8 This is a chromatogram after transesterification in a case of using palm oil as a result of the verification experiment in Example 5.

FIG. 9 This shows a reaction rate of triglyceride relative to different catalysts under two-phase separation condition as a result of the verification experiment in Example 6.

FIG. 10 This includes photographic pictures showing the observation result in 24 hours after transesterification under two-phase separation condition as a result of the verification experiment in Example 6.

### BEST MODE FOR CARRYING OUT THE INVENTION

The invention is characterized by the above, and the best mode for carrying out the invention is described below.

In the invention, the fibrous catalyst to be used in production of biodiesel by transesterification of oil/fat and alcohol comprises a graft polymer of a polymer fiber substrate with a graft chain introduced thereinto, in which the graft chain has one or more functional groups selected from primary amino groups, secondary amino groups, tertiary amino groups and quaternary ammonium groups, and a hydroxide ion.

As the polymer fiber substrate, used are polymer fibers, for example, polyolefin fibers of polyethylene, polypropylene or the like, or natural polymer fibers of chitin, chitosan, cellulose, starch or the like; and they are used as thread-like ones or as fiber aggregates of woven fabrics, nonwoven fabrics or hollow yarn membranes. The mean fiber diameter of the polymer fibers may be from 1 μm to 50 μm, preferably from 2 μm to 30 μm.

As a biodiesel production catalyst, it has heretofore been known to use a granular porous anion exchange resin; however, in the invention, a fibrous polymer having a large specific surface area and having a high contact efficiency is used s the substrate, and therefore, as compared with conventional ones, the catalyst of the invention may act to produce biodiesel more efficiently within a shorter period of time. Moreover, under a low-temperature condition, for example, at a reaction temperature of from 10° C. to 100° C., especially under a condition of from 20° C. to 50° C., biodiesel can be produced efficiently, and therefore, the biodiesel production cost may be reduced.

A method for producing a biodiesel production catalyst and a method of using the catalyst for producing a biodiesel are described in more detail hereinunder.

### [1] Method for Producing Biodiesel Production Catalyst:

The method for producing a biodiesel production catalyst includes the following two. Specifically, the first method comprises a step of activating a polymer fiber substrate (polymer fiber substrate activation step), a step of contacting the activated polymer fiber substrate with a solution containing an active monomer to thereby graft-polymerize the polymer fiber substrate with the reactive monomer (graft polymerization step), a step of introducing one or more functional groups selected from primary amino groups, secondary amino groups, tertiary amino groups and quaternary ammonium groups into the graft chain formed by the graft polymerization (functional group introductions step), and a step of alkali-processing the graft-polymerized polymer fiber substrate (alkali processing step). The second method comprises a step of activating a polymer fiber substrate (polymer fiber substrate activation step), a step of contacting the activated polymer fiber substrate with a solution that contains an active monomer having one or more functional groups selected from primary amino groups, secondary amino groups, tertiary amino groups and quaternary ammonium groups to thereby graft-polymerize the polymer fiber substrate with the reactive monomer (graft polymerization step), and a step of alkali-processing the graft-polymerized polymer fiber substrate (alkali-processing step).

### [1-1] Polymer Fiber Substrate:

The material constituting the polymer fiber material is not specifically defined, and as described in the above, its examples include polyolefin fibers of polyethylene, polypropylene or the like, and natural polymer fibers of chitin, chitosan, cellulose, starch or the like. The form of the polymer fiber substrate may be any of fiber aggregates of woven fabrics, nonwoven fabrics or hollow yarn membranes, or thread-like ones. The mean fiber diameter of the polymer fibers may be from 1 μm to 50 μm, preferably from 2 μm to 30 μm.

### [1-2] Reactive Monomer:

The reactive monomer is a reactive monomer having a vinyl group; and one or more different types of monomers may be mixed for use herein. In case where a monomer mixture is used, the concentration ratio of the monomers is not specifically defined and may be determined in any desired manner.

The monomer having a vinyl group is not specifically defined, including, for example, chloromethylstyrene (CMS), glycidyl methacrylate, etc.

As the reactive monomer having a vinyl group, also usable are vinyl monomers already having one or more functional groups selected from primary amino groups, secondary amino groups, tertiary amino groups and quaternary ammonium groups. Their examples include allylamine, N-methylallylamine, N,N-dimethylallylainine, acrylamide, N-isopropylacrylamide, N,N-dimethylacrylamide, (3-acrylamidopropyl)trimethylammonium chloride, [3-(methacryloylamino)propyl]trimethylammonium chloride, vinylaniline, N,N-dimethylvinylbenzylamine, (vinylbenzyl)trimethylammonium chloride, etc.

### [1-3] Reactive Monomer-Containing Solution:

In this embodiment, as the solution containing a reactive monomer, usable are two types of reaction solutions of an emulsion reaction solution and a non-emulsion reaction solution. From the viewpoint of increasing the graft ratio in the polymer fiber substrate, preferred is use of the emulsion reaction solution.

The emulsion reaction solution comprises a reactive monomer, a surfactant and water, and this is a system where the reactive monomer liquid droplets insoluble in water are dispersed in the water-base solvent. The size of the reactive monomer liquid droplets is not specifically defined, including microemulsions in a size of from a few am to a few tens μm or so, and nanoemulsions in a size of from a few nm to a few tens nm. Accordingly, so far as a reactive monomer liquid insoluble in water and a water-base solvent exist therein, the system falls within the concept of the emulsion reaction solution where the constitutive ingredients are apparently uniformly mixed owing to addition of a surfactant thereto to lower the surface tension between water/oil.

As the surfactant, any one generally used in the art may be suitably selected and used herein, including anionic surfactants, cationic surfactants, ampholytic surfactants, nonionic surfactants, etc. One or more different types of surfactants may be used, as combined. Not specifically defined, the anionic surfactants include alkylbenzene-type, alcohol-type, olefin-type, phosphate-type, amide-type surfactants, etc. For example, there is mentioned sodium dodecylbenzenesulfonate. Also not specifically defined, the cationic surfactants include octadecylamine acetate, trimethylammonium chloride, etc. Not specifically defined, the nonionic surfactants include ethoxylated fatty alcohols, fatty acid esters, etc. For example, there is mentioned polyoxyethylene(20) sorbitan monolaurate (Tween 20). Not specifically defined, the ampholytic surfactants include, for example, Amphitol® (by Kao).

The concentration of the surfactant to be used is not specifically defined, and may be suitably determined depending on the type and the concentration of the reactive monomer. The concentration of the surfactant is preferably from 0.1 to 10% by weight based on the total weight of the solvent.

Use of the surfactant promotes the dispersion of the reactive monomer insoluble in water, in the water-base solvent. The outward appearance of the emulsion variously changes depending on the size of the liquid droplets of the dispersed phase; but in general, it looks milky and opaque and may become transparent with the decrease in the size of the liquid droplets from microemulsion to nanoemulsion.

Not specifically defined, water for use herein may be any of distilled water, ion-exchanged water, pure water, ultra-pure water. Use of water solves the problem of waste treatment, and follows environmental protection.

The non-emulsion reaction solution comprises a reactive monomer and an organic solvent. Not specifically defined, the organic solvent includes, for example, alcohols such as methanol; and mixed solvents of alcohol and water, etc.

### [1-4] Polymer Fiber Substrate Activation Step:

“Activation” in this description means a step of forming a reaction active point for graft polymerization of a polymer fiber substrate with a reactive monomer. The polymer fiber substrate activated in this step is contacted with a solution containing a reactive monomer, thereby graft-polymerizing the reactive monomer on the main chain of the polymer fiber substrate in the next graft polymerization step. During forming the reaction active point, the substrate may be damaged as the substrate molecules may be cut; but in graft polymerization in an emulsion-state water-base solvent or an organic solvent in the next step, the irradiation dose necessary for activation may be reduced and the polymer fiber substrate may be prevented from being damaged.

The polymer fiber substrate may be activated as follows: The polymer fiber substrate is previously purged with nitrogen, and irradiated with radiations in a nitrogen atmosphere at room temperature or while cooled with dry ice or the like. The radiations to be used may be electron beams or γ rays; and the radiation dose may be suitably determined under the condition that the dose is enough to form the reaction active point. For example, the dose may be from 1 to 200 kGy or so, preferably from 20 to 100 kGy.

### [1-5] Graft Polymerization Step:

The polymer fiber substrate activated in the polymer fiber substrate activation step is contacted with a solution of a reactive monomer, thereby graft-polymerizing the polymer fiber substrate with the reactive monomer. In this step, a graft polymer is produced in which a graft chain from the reactive monomer is introduced into the main chain of the polymer fiber substrate.

The graft polymerization may be attained in a nitrogen atmosphere; but the oxygen concentration in the atmosphere is preferably lower for securing a high graft ratio. “Graft ratio” as referred to herein is meant to indicate the increase in the weight (%) of the reactive monomer grafting on the polymer substrate. The reaction temperature depends on the reactivity of the reactive monomer, but is typically from 10 to 60° C., preferably from 30 to 60° C. The reaction time falls within a range of from 5 minutes to 6 hours, preferably from 10 minutes to 4 hours, and may be determined depending on the reaction temperature, and the desired graft ratio. The monomer concentration may be generally from 0.1 to 30% by weight, preferably from 1 to 10% by weight; but along with the reaction temperature and the reaction time, this may also be a factor of determining the reaction rate, and therefore may be determined suitably.

In this step, when a reactive monomer already having, as a functional group, any of primary amino groups, secondary amino groups, tertiary amino groups or quaternary ammonium groups is used, then the step of introducing a functional group into the graft chain, which will be described below, may be omitted.

### [1-6] Functional Group Introducing Step:

Next to the graft polymerization step, a functional group is introduced into the graft chain of the graft polymer. In the step of introducing a functional group into the graft chain, a catalyst function for biodiesel production can be imparted to the polymer fiber substrate. The functional group to be introduced into the graft chain is one or more selected from primary amino groups, secondary amino groups, tertiary amino groups and quaternary ammonium groups; and this may be introduced through amination of the graft chain with amines such as trimethylamine (TMS), dimethylamine, methylamine, ammonia, ethylenediamine, diethanolamine, etc. For example, in Examples given hereinunder, a graft polymer in which a graft chain of a reactive monomer (CMS) is introduced into the main chain of the polymer fiber substrate, is produced by dipping the substrate in an aqueous TMA solution to thereby introduce a graft chain of a quaternary ammonium group thereinto. The quaternary ammonium group is strong basic, and the graft polymer into which the quaternary ammonium group is introduced as the graft chain therein can be a strong basic anion exchange graft polymer. The strong basic anion exchange graft polymer can take a larger quantity of hydroxide ions in the alkali-processing step to be mentioned hereinunder, and it therefore considered as a favorable embodiment. In particular, in the graft polymer with TMA, the alkyl chain length of the alkyl group (methyl group) bonding to the nitrogen atom in TMA is short, and therefore, the graft polymer is favorable since the steric hindrance therein is smaller and the reactivity of the polymer is higher.

The reaction temperature in introducing the functional group into the graft chain depends on the reactivity of the amines, and it typically from 10 to 60° C., preferably from 40 to 60° C. The reaction time may be within a range of from 5 minutes to 24 hours, preferably from 10 minutes to 2 hours. The concentration of the amines may be generally within a range of from 0.1 to 5 mol/L, preferably from 0.25 to 1 mol/L.

### [1-7] Alkali-Processing Step:

Next, the graft polymer with a functional group introduced into the graft chain therein is alkali-processed. Accordingly, a hydroxide ion is introduced into the graft chain to give a catalyst for biodiesel production. A concrete processing method is described. For example, the graft polymer is dipped in an aqueous alkaline solution such as 0.5 to 2 mol/L NaOH or KOH, and stirred at room temperature (about 25° C.) for at least 6 hours, whereby the pair ion of the functional group introduced into the graft chain is substituted with a hydroxide ion and the hydroxide ion is thereby introduced into the graft chain. After the substitution reaction, the graft polymer is fully washed with water for removing the unreacted alkali, and thereafter this is again washed with a predetermined alcohol.

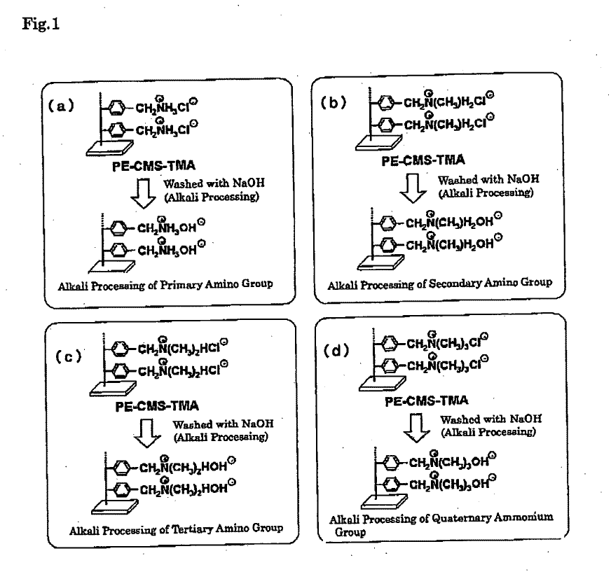

FIG. 1 shows alkali-processing of graft polymers for hydroxide ion introduction thereinto, in which polyethylene is used as a polymer fiber substrate and CMS is used as a reactive monomer for introduction of a primary amino group, a secondary amino group, a tertiary amino group or a quaternary ammonium group as a functional group thereinto. (a) shows alkali-processing of a graft polymer with a primary amino group introduced thereinto; and (b), (c) and (d) each show alkali-processing of a graft polymer with a secondary amino group, a tertiary amino group or a quaternary ammonium group, respectively, introduced thereinto. In these examples, the pair ion, chloride ion to the functional group introduced into the graft chain is substituted with a hydroxide ion through the alkali-processing. The chloride ion is an ion derived from CMS of the reactive monomer.

In case where the functional group is a quaternary ammonium group, this is strong basic and its pair ion is completely dissociated in the aqueous alkaline solution. On the other hand, in case where the functional group is a primary amino group, a secondary amino group or a tertiary amino group, this is weak basic and is not completely dissociated; and even in alkali-processing, a part of the chloride ions could not be substituted with a hydroxide ion. Accordingly, as compared with that into the graft polymer with a primary amino group, a secondary amino group or a tertiary amino group introduced thereinto, the amount of the hydroxide ions to be introduced into the graft polymer with a quaternary ammonium group introduced thereinto can be large and the reactivity of the resulting polymer in transesterification biodiesel production can favorably increase.

### [2] Method of Using Biodiesel Production Catalyst for Production of Biodiesel:

Biodiesel can be produced as a fatty acid ester by transesterification of oil/fat and alcohol in the presence of the biodiesel production catalyst produced in this embodiment (hereinafter this may be referred to as a fibrous catalyst). Not specifically defined, the molar ratio of oil/fat to alcohol (oil-fat/alcohol) may fall within a range of from 1/100 to 1/3, preferably from 1/3 to 1/20.

In transesterification of oil/fat and alcohol, an auxiliary solvent may be used for mixing the reactant materials in a homogeneous phase and reacting them. The auxiliary solvent may be in an amount enough for the reactant materials to form a homogeneous phase, though depending on the type and the ratio of oil/fat and alcohol; and the auxiliary solvent may be added to the system in a ratio of from 0.1 to 500% by weight relative to the total weight of the reactant materials, preferably from 0.1 to 100% by weight.

The reaction temperature is not specifically defined. In this embodiment, biodiesel can be produced at a temperature falling within a range of from 10° C. to 100° C. In this embodiment, the fibrous catalyst is used, and for example, even in a low-temperature condition falling within a range of from 20° C. to 50° C., biodiesel can be produced. The reaction time may fall within a range of from 5 minutes to 24 hours, preferably from 10 minutes to 4 hours. The method of contacting the reactant materials of oil/fat and alcohol with the fibrous catalyst is not specifically defined, and may be any of a batch process, a continuous process, etc. For example, employable are a method of using a stirring tank, a method of leading the liquid into a packed bed, and a method of using a fluidized bed reactor, a shaking reactor or the like. In batch transesterification, the reaction system is stirred for enhancing the reaction efficiency. The stirring speed may be within a range of from 10 to 1000 rpm, preferably from 200 to 500 rpm.

The catalyst activity of the fibrous catalyst lowers since the free fatty acid formed through hydrolysis to occur along with the transesterification, is adsorbed by the fibrous catalyst. Accordingly, after the transesterification, the catalyst is washed with an acid solution whereby the catalyst activity is restored and the catalyst can be repeatedly used. As the acid solution, usable is an organic acid such as formic acid, acetic acid, citric acid, etc.

### [2-1] Oil/Fat:

Oil/fat for use in production of biodiesel is not specifically defined, including natural oil/fat, synthetic oil/fat, or their mixtures. For example, they are vegetable oil/fat such as palm oil, palm kernel oil, linseed oil, sunflower oil, wood oil, safflower oil, cotton seed oil, corn oil, soybean oil, rapeseed oil, canola oil, sesame oil, rice oil, olive oil, peanut oil, castor oil, cacao butter, coconut oil, safflower oil, curcas oil, phlox oil, sandbox oil; animal oil/fat such as beef tallow, lard, cream, fish oil, whale oil; vegetable oils discarded by restaurants, food industries, private households, etc. These oil/fat may be used singly or as mixed oil/fat thereof; and also usable are oil/fat containing diglyceride or monoglyceride, synthetic triglyceride, synthetic triglyceride containing monoglyceride or diglyceride, modified oil/fat prepared by oxidizing or reducing a part of these oil/fat. Processed oil/fat products comprising these oil/fat as the main ingredient are also usable as the starting material.

Oil/fat may contain any other ingredient than oil/fat. Concretely mentioned are crude oil, heavy oil, light gas oil, mineral oil, essential oil, coal, fatty acid, saccharide, metal powder, metal salt, protein, amino acid, hydrocarbon, cholesterol, flavor, dye compound, enzyme, perfume, alcohol, fiber, resin, rubber, paint, cement, detergent, aromatic compound, aliphatic compound, soot, glass, earth and sand, nitrogen-containing compound, sulfur-containing compound, phosphorus-containing compound, halogen-containing compound, etc., to which, however, the invention is not limited. The heterogeneous ingredients in oil/fat are preferably removed through precipitation, filtration, liquid-liquid separation, etc.

### [2-2] Alcohol:

Not specifically defined, alcohol for use in producing biodiesel may be any one capable of directly transesterifying with oil/fat, including saturated, linear or branched hydrocarbon skeleton—having alcohols having from 1 to 18 carbon atoms, preferably from 1 to 6 carbon atoms. For example, there are mentioned methanol, ethanol, propanol, isopropanol, 1-butanol, 2-butanol, isobutanol, tert-butanol, 1-pentanol, 3-pentanol, 3-methyl-1-butanol, 2,2-dimethyl-1-propanol, 1-hexanol, 2-hexanol, 2-methyl-1-pentanol, 3,3-dimethyl-1-butanol, etc. One or more these alcohols may be used either singly or as combined. In this embodiment, preferred is use of methanol or ethanol from the viewpoint of the availability thereof and the applicability of the fatty acid to be obtained.

### [2-3] Auxiliary Solvent:

The auxiliary solvent for use in this embodiment is one for increasing the contact interface between oil/fat and alcohol in transesterification of oil/fat and alcohol in producing biodiesel, and for increasing the reaction speed of transesterification. Accordingly, the auxiliary solvent is not specifically defined so far as it is completely miscible with both oil/fat and alcohol and the auxiliary solvent itself does not react with the reactant materials. For example, it includes linear saturated hydrocarbons such as decane, octane, hexane; cyclic saturated hydrocarbons such as cyclohexane; aromatic compounds such as benzene, xylene, toluene; ethers such as diethyl ether, dipropyl ether, tert-butyl methyl ether; cyclic ethers such as tetrahydrofuran, dioxane; aprotic polar solvents such as N,N-dimethylformamide, dimethyl sulfoxide, acetone, etc. As the auxiliary solvent, also usable is commercially-available biodiesel or biodiesel produced according to this embodiment. The volume of the necessary auxiliary solvent may be suitably determined depending on the type of the fat/oil and alcohol and on the affinity of the solvent with the reactant materials.

The auxiliary solvent must be removed from the reaction product after the transesterification, and preferably, therefore, it has a boiling point lower than about 200° C., more preferably, it has a boiling point near to the boiling point of the alcohol to be used. Also preferably, the auxiliary solvent is an anhydrous one.

The invention has been described hereinabove with reference to the embodiments thereof; however, the invention is not limited at all to the above-mentioned embodiments. Not overstepping the spirit and the scope thereof, the invention may be changed and modified in any manner within the scope of the invention. Examples of the invention are concretely described hereinunder.

### EXAMPLES

### Production of Catalyst for Biodiesel Production

### Example 1

As a polymer fiber substrate, used was a nonwoven fabric of polyethylene/polypropylene (PE/PP) fibers (mean fiber diameter: 13 μm); and this was irradiated with electron beams (irradiation dose: 20 to 100 kGy) in a nitrogen atmosphere. After irradiation, the sample was dipped in an emulsion reaction solution (p-chloromethylstyrene (CMS) concentration: 3 wt. %, Tween 20 concentration: 0.3 wt. %) for graft polymerization at a reaction temperature of 40° C. for 1 to 4 hours. The emulsion reaction solution comprises three ingredients of a functional monomer CMS, a surfactant Tween 20 and a solvent water; and in this experiment, the emulsion reaction solution was previously purged with nitrogen so as to remove oxygen dissolving therein, and the thus-processed, solution was used. After the graft polymerization, this was fully washed with water and methanol in that order to give the intended CMS-graft polymer. The degree of grafting (Dg) was computed according to the following formula, based on the weight increase in the nonwoven fabric before and after the graft polymerization.

Degree of Grafting(Dg,%)=(W₁−W₀)/W₀=100

wherein W₀ and W₁ each indicate the substrate weight before graft polymerization and after graft polymerization, respectively.

Using a non-emulsion reaction solution with an organic solvent (methanol), the same graft polymerization as above was also carried out. The reaction condition for the non-emulsion system was the same as that for the emulsion system, except that methanol was used as the solvent. The irradiation dose was 100 kGy, the CMS concentration was 3% by weight, the reaction temperature was 40° C. and the reaction time was 1 to 4 hours.

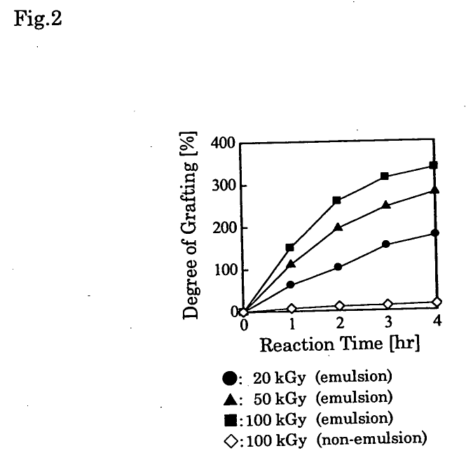

FIG. 2 shows the degree of grafting that varies depending on the irradiation dose and the reaction time. The degree of grafting of the emulsion system in a reaction time of 4 hours was 177% at 20 kGy, 278% at 50 kGy, and 337% at 100 kGy. The degree of grafting of the non-emulsion system in a reaction time of 4 hours around 15% at an irradiation dose of 100 kGy.

Next, the CMS-graft polymer was dipped in an aqueous trimethylamine (TMA) solution having a TMA concentration of 0.25 mol/L, at a reaction temperature of 50° C. for 2 hours for introduction of a quaternary ammonium group into the CMS graft chain. The CMS-graft polymer had a degree of grafting of 100%, 200%, 300% or 400%. These CMS-graft polymers were produced according to the above-mentioned method, in which the reaction time was controlled to make the polymers have the predetermined degree of grafting.

As a result of introduction of the quaternary ammonium group into the CMS graft chain, the density of the functional group in the graft polymers having a different degree of grafting, as produced by the use of an emulsion-type reaction solution, was 2.7 mmol-TMA/g-catalyst at a degree of grafting of 100%, 3.3 mmol-TMA/g-catalyst at a degree of grafting of 200%, 3.6 mmol-TMA/g-catalyst at a degree of grafting of 300%, and 3.7 mmol-TMA/g-catalyst at a degree of grafting of 400%. The functional group density is on the same level as that of the functional group density, 3.4 mmol-TMA/g-resin which a commercially-available granular strong basic anion exchange resin (Mitsubishi Chemical's Diaion PA306S) has; and this Example confirms the production of a strong basic anion exchange graft polymer (fibrous catalyst) having a functional group capacity enough for practical use.

### Production of Biodiesel with Fibrous Catalyst

### Example 2

### Influence of Reaction Time on Transesterification

Using the strong basic anion exchange graft polymer (fibrous catalyst) of the invention, biodiesel (fatty acid ester) was produced by transesterification of oil/fat (triglyceride) and alcohol. As the oil/fat, used was a synthetic triglyceride, triolein (purity, 60%); and as the alcohol, used was ethanol. 10 g of a reactant material prepared by mixing the two in a ratio by mol (triolein/ethanol) of 1/50 (triolein, 2.8 g (3.2 mol); ethanol, 7.2 g (156 mol)) was collected in a 50-mL vial bottle, and 10 g of an auxiliary solvent, decane (by Wako Pure Chemicals, purity 99.0%) added thereto for making the reaction solution a homogeneous phase. Next, 0.5 g (dry weight) of the fibrous catalyst previously pre-treated with an aqueous sodium hydroxide solution was added to it for transesterification at a reaction temperature of 50° C. and at a stirring speed of 300 rpm. The degree of grafting of the fibrous catalyst used in this was 255%, and the functional group density therein was 3.5 mmol-TMA/g-catalyst.

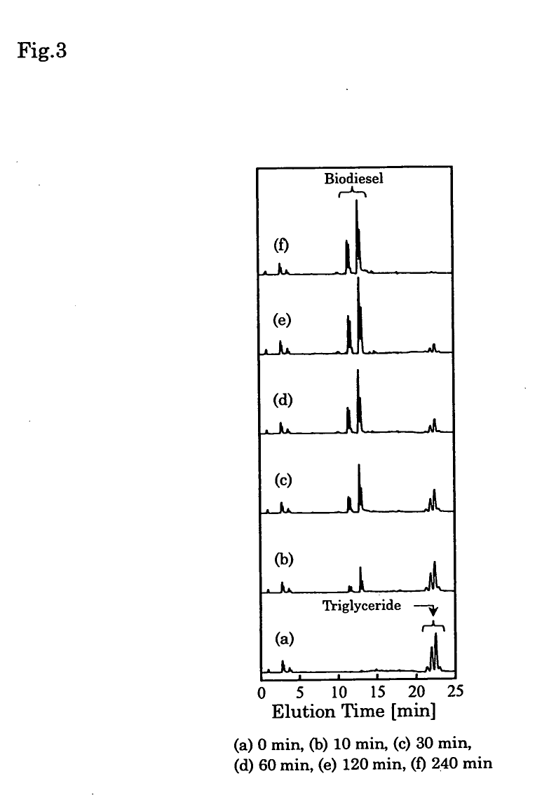

Transesterification of oil/fat and alcohol in the presence of the strong basic anion exchange graft polymer gave biodiesel through consumption of triglyceride with the lapse of time, as shown in FIG. 3. The result confirms that the strong basic anion exchange graft polymer functions as a catalyst for biodiesel production. The reaction rate of transesterification in different reaction times was 23% in a reaction time of 10 minutes, 48% in a reaction time of 30 minutes, 70% in a reaction time of 60 minutes, 82% in a reaction time of 120 minutes and 95% in a reaction time of 240 minutes.

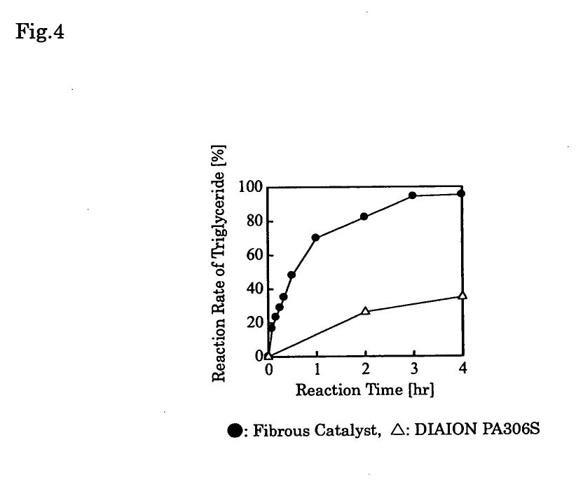

Triglyceride in FIG. 3 is specifically noted; and the reaction rate of triglyceride relative to the reaction time is plotted as in FIG. 4. In FIG. 4, the data with a commercially-available granular strong basic anion exchange resin, Diaion PA306S are also shown for comparison.

The functional group density in Diaion PA306S used in this experiment was 3.4 mmol-TMA/g-resin, and the particle size of the resin was 150 to 425 μm. The amount of the resin was so controlled that the amount of the functional group to be introduced into the reaction system could be the same as that to be introduced thereinto in the case of using the fibrous catalyst, and 0.5 g of the resin, as the dry weight thereof, was used. The other condition was the same as that in the case of using the fibrous catalyst.

As shown in FIG. 4, the fibrous catalyst promoted the transesterification at a reaction speed higher by at least 3 times than that with the granular strong basic anion exchange resin (granular resin), and it is known that the fibrous catalyst produced biodiesel efficiently within a shorter period of time. The triglyceride reaction rate in a reaction time of 2 hours was 82% with the fibrous catalyst and 26% with the granular resin.

### Example 3

### Influence of Reaction Temperature on Transesterification

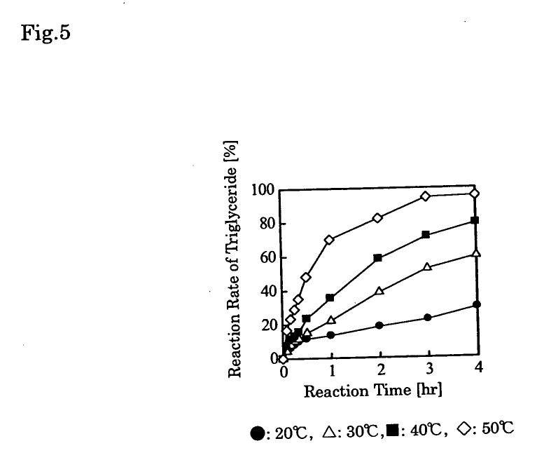

FIG. 5 shows the result of investigation of the influence of the reaction temperature on transesterification.

In this experiment, used was a fibrous catalyst having a degree of grafting of 215% and a functional group density of 3.3 mmol-TMA/g-catalyst. The other condition was the same as in Example 2.

As in FIG. 5, use of the fibrous catalyst enabled production of biodiesel even under a low temperature condition of a reaction temperature of 20° C. to 50° C. With the elevation of the reaction temperature, the transesterification rate increased; and after the reaction time of 4 hours, the triglyceride reaction rate at different reaction temperatures was 18% at 20° C., 39% at 30° C., 58% at 40° C. and 82% at 50° C.

### Example 4

### Production of Biodiesel with Different Types of Alcohols

Using triolein as oil/fat and using a primary alcohol having a different alkyl chain length as alcohol, the two ingredients were transesterified. The results are shown in FIG. 5.

In this Example, methanol, ethanol, 1-propanol, 1-butanol, 1-pentanol and 1-hexanol were used as alcohol; and a fibrous catalyst having a degree of grafting of 307% and a functional group density of 3.6 mmol-TMA/g-catalyst was used. The reaction time was 2 hours, and the other condition was the same as in Example 2.

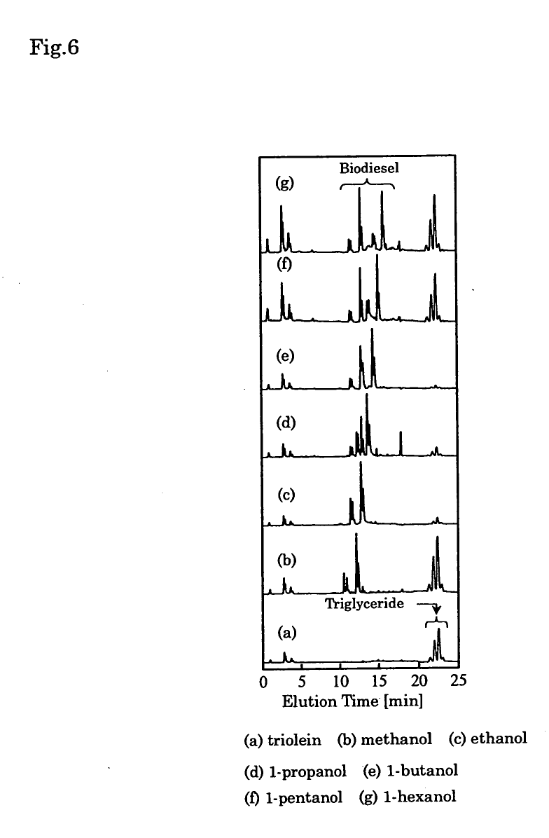

As in FIG. 6, biodiesel was produced irrespective of the type of alcohol used; and it is known that the fibrous catalyst is a biodiesel production catalyst applicable to other various types of alcohols than ethanol. From the peaks of biodiesel in FIG. 6, it is known that the alcohol having a longer alkyl chain length took a longer elution time. The difference in the elution time means the difference in the structure (hydrophobicity) of the biodiesel produced, and it is known that different types of biodiesel are produced from different types of alcohol. The reaction rate in transesterification with different alcohols after the reaction time of 2 hours was 48% with methanol, 84% with ethanol, 82% with 1-propanol, 89% with 1-butanol, 53% with 1-pentanol and 44% with 1-hexanol.

### Example 5

### Production of Biodiesel from Starting Material of Different Types of Oil/Fat

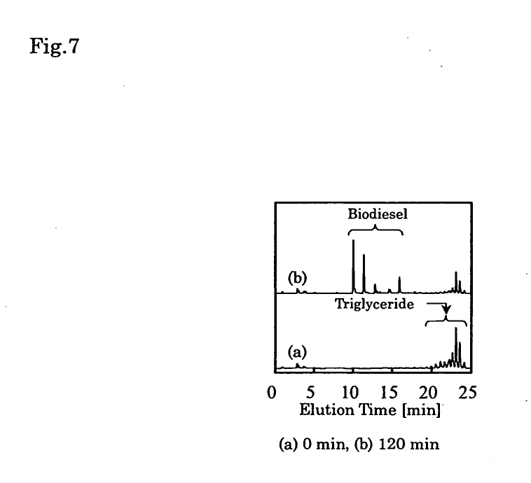

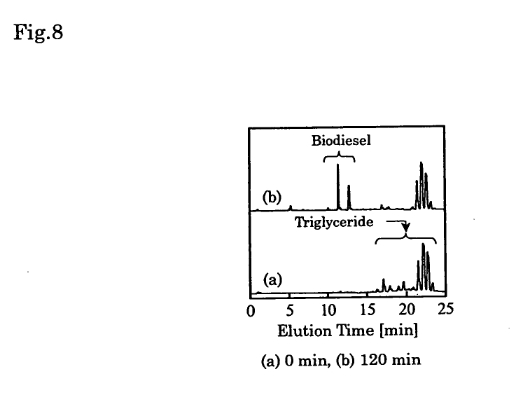

FIG. 7 and FIG. 8 show results of production of biodiesel through transesterification of rapeseed oil or palm oil as oil/fat and ethanol.

In this Example, a fibrous catalyst having a degree of grafting of 307% and a functional group density of 3.6 mmol-TMA/g-catalyst was used; and as the reactant material, a mixed solution of 2.8 g of oil/fat, 7.2 g of ethanol and 10 g of decane was used. The reaction time was 2 hours, and the other condition was the same as in Example 2.

An actual sample of rapeseed oil or palm oil has various types of triglycerides, different from the model sample such as triolein used in the above; but as in FIG. 7 and FIG. 8, the actual sample also produced biodiesel. In the reaction time of 2 hours, the reaction rate of the different reactions systems was 47% from rapeseed oil and 30% from palm oil. The reaction rate was relatively low; but the reaction rate can be increased by optimizing the solid-liquid ratio of the fibrous catalyst and the oil/fat and the ratio of the oil/fat and the alcohol.

### Example 6

### Production of Biodiesel with No Trouble of Two-Phase Separation

In the above-mentioned Examples, an auxiliary solvent was added to the reactant material for the purpose of removing the influence of the stirring operation on the reaction speed and for increasing the reaction efficiency in production of biodiesel. However, the auxiliary solvent must be separated and removed from the product after the reaction, but this is problematic as increasing the production cost. Accordingly, in this Example, for the purpose of reducing the production cost of biodiesel, biodiesel production was tried in a two-phase separation state not using an auxiliary solvent. In this experiment, 10 g of a mixed solution of triolein and ethanol alone (ratio by mol of triolein/ethanol=1/10) was used as the reactant material; and a fibrous catalyst having a degree of grafting of 200% and a functional group density of 3.3 mmol-TMA/g-catalyst was used. The other condition was the same as in Example 3. For comparison, the data with a granular strong basic anion exchange resin, Diaion PA306S (functional group density, 3.4 mmol-TMA/g-resin; dry weight, 0.5 g) are also shown.

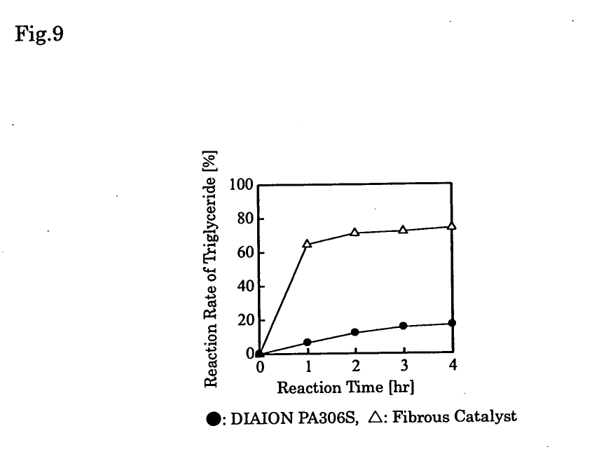

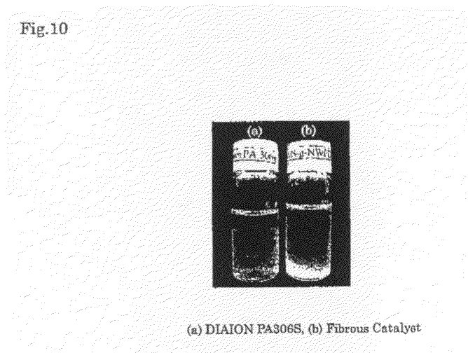

FIG. 9 shows the data of the reaction rate of triglyceride, as plotted relative to the reaction time; and FIG. 10 shows photographic pictures of reaction solutions in 24 hours after the start of transesterification. As in FIG. 9, both the fibrous catalyst and the granular ion exchange resin were effective for producing biodiesel in the absence of an auxiliary solvent. However, when the two cases are compared with each other in point of the triglyceride reaction rate in 1 hour after the start of the reaction, then it is known that the reaction rate with the fibrous catalyst was about 10 times that with the granular ion exchange resin (fibrous catalyst, 64%; granular ion exchange resin, 6%), and that the fibrous catalyst attained more rapid and more efficient transesterification. The significant difference in the reaction speed is not only caused by the effect of the fibrous graft polymer catalyst having a high contact efficiency and a high reaction efficiency but also caused by the synergistic effect with the fibrous catalyst in that, even when an auxiliary solvent is not used, the fibrous catalyst could be effective for producing a sufficient amount of biodiesel enough for solving the problem of two-phase separation within a short period of time, and as a result, the produced biodiesel could function as an auxiliary solvent (self-formation of auxiliary solvent).

The result could be understood from the photographic pictures in FIG. 10. As in FIG. 10(a), in the case where the granular ion exchange resin was used, the amount of biodiesel produced was still small even in 24 hours after the start of the reaction, and the reaction solution was separated in two phases. On the other hand, in the case where the fibrous catalyst was used, the phase separation in the reaction system was solved owing to the auxiliary solvent effect of the large quantity of biodiesel produced with high efficiency and the reaction system formed a homogeneous phase, as in FIG. 10(b).

As in the above, use of the fibrous catalyst makes it possible to produce biodiesel in the absence of an auxiliary solvent. Accordingly, the auxiliary solvent removal step can be omitted, and the production cost can be reduced.

### INDUSTRIAL APPLICABILITY

The catalyst for biodiesel production of the invention comprises a fibrous polymer insoluble in the reaction solution, as a substrate, and therefore, it makes it possible to omit the catalyst separation step that is a drawback in a homogenous-phase alkali catalyst method. In addition, the fibrous catalyst comprises ultrafine fibers having a large specific surface area and a high contact efficiency, and comprises a graft polymer having a higher reaction speed as the catalytic ingredient thereof, and therefore, it enables production of a large quantity of biodiesel efficiently and at a reaction speed higher by at least 3 times than that with conventional granular ion exchange resins. Further, the fibrous catalyst enables production of biodiesel in the absence of an auxiliary solvent. Accordingly, the auxiliary solvent removal step can be omitted, and the production cost can be reduced. Moreover, the fibrous catalyst enables production of biodiesel at a reaction temperature not higher than 50° C. Accordingly, the catalyst has a possibility of great contribution toward the industrial field and the energy field as an inexpensive and efficient biodiesel production technology. Further promotion of using biodiesel having a smaller environmental load may contribute toward solving the current serious issue of global warming and aerial pollution and further toward solving the issue of depletion of fossil fuel resources.

That is, according to the invention, the following advantages are expected.

(1) In a graft polymerization method, a fibrous catalyst for biodiesel can be produced with good reproducibility and in a simplified manner

(2) A catalyst removal step, which is a defect in a homogeneous-phase alkali catalyst method, can be omitted.

(3) A fibrous polymer having a large specific surface area and having a high-level contact efficiency is used as a substrate, and therefore, as compared with a case of using a conventional granular ion exchange resin, a biodiesel can be produced more efficiently within a shorter period of time in the case of using the catalyst of the invention.

(4) Different from a granular ion exchange resin having a reaction site inside the pores, the catalyst of the invention comprises a graft polymer having a reaction site in the graft chain thereof and therefore exhibiting a higher reaction efficiency; and using the catalyst, a biodiesel can be produced more efficiency within a shorter period of time.

(5) Different from a conventional two-phase biodiesel production method, the transesterification in the invention is attained in a homogeneous phase owing to the action of the formed biodiesel, and therefore in the invention, the reaction efficiency is enhanced more and biodiesel can be produced more efficiently within a shorter period of time.

(6) An auxiliary solvent is not needed, and therefore an auxiliary solvent removal step can be omitted and the biodiesel production cost can be reduced.

(7) The transesterification can be attained at a temperature not higher than 50° C., and therefore the biodiesel production cost can be reduced.

(8) Biodiesel to be produced from a starting material of vegetable oil/fat is a “carbon-neutral” fuel, and therefore follows global warming preventive measures.

(9) As compared with that in petroleum-derived light gas oil, the content in biodiesel of sulfur oxides that cause dark smoke in exhaust gas and acid rain is small, and suspending particulate matter generation is small, and therefore the environmental load may be reduced.

1. A fibrous catalyst for production of biodiesel by transesterification of oil/fat and alcohol,
the catalyst for biodiesel production being characterized in that a graft chain is introduced into a polymer fiber substrate through graft polymerization, and the graft chain has one or more functional groups selected from amino groups and quaternary ammonium groups, and a hydroxide ion.

2. The catalyst for biodiesel production as claimed in claim 1, wherein the polymer fiber substrate is a thread-like one or a fiber aggregate of a woven fabric, a nonwoven fabric or a hollow yarn membrane.

3. The catalyst for biodiesel production as claimed in claim 1, wherein the mean fiber diameter of the polymer fiber substrate is from 1 μm to 50 μm.

4. A method for producing the catalyst for biodiesel production of claim 1,
which comprises a step of activating a polymer fiber substrate, a step of contacting the activated polymer fiber substrate with a solution containing an active monomer to thereby graft-polymerize the polymer fiber substrate with the reactive monomer, a step of introducing one or more functional groups selected from amino groups and quaternary ammonium groups into the graft chain of the graft-polymerized polymer fiber substrate, and a step of alkali-processing the graft-polymerized polymer fiber substrate.

5. A method for producing the catalyst for biodiesel production of claim 1,
which comprises a step of activating a polymer fiber substrate, a step of contacting the activated polymer fiber substrate with a solution that contains an active monomer having one or more functional groups selected from amino groups and quaternary ammonium groups to thereby graft-polymerize the polymer fiber substrate with the reactive monomer, and a step of alkali-processing the graft-polymerized polymer fiber substrate.

6. A method for producing a biodiesel, comprising contacting oil/fat and alcohol with the biodiesel production catalyst of claim 1 to thereby produce a biodiesel through transesterification of oil/fat and alcohol.

7. The method for producing a biodiesel as claimed in claim 6, wherein the oil/fat is any of natural oil/fat, synthetic oil/fat, monoglyceride, diglyceride, synthetic triglyceride, their modificates, or waste oil/fat containing any of them.

8. The method for producing a biodiesel as claimed in claim 6, wherein the alcohol includes one or more mixed alcohol selected from linear or branched alcohols having from 1 to 18 carbon atoms.

9. The method for producing a biodiesel as claimed in claim 6, wherein the reaction temperature falls within a range of from 10° C. to 100° C.
